(19) United States
(12) Patent Application Publication
(10) Pub. No.: US 2012/0049622 A1
(43) Pub. Date: Mar. 1, 2012

(54) OFFSHORE COMPOUND RENEWABLE POWER PLANT

(76) Inventors: JAMES YOUNG, Taipei City (TW); Yaw-Chung Cheng, Taipei City (TW); Shou-Shan Chen, Taipei City (TW)

(21) Appl. No.: 12/868,707

(22) Filed: Aug. 25, 2010

(51) Int. Cl. H02J 3/38

(52) U.S. Cl. 307/21

(57) ABSTRACT

An offshore compound renewable power plant, which is built in an on-sea plant site, includes marine platforms set up in the on-sea plant site in a spaced manner and wind power generation systems respectively installed on the marine platforms for receiving winds to generate electrical power. An ocean energy based electrical power generation system or a marine production system is further included in the on-sea plant site, whereby the wind power generation systems and the ocean energy based electrical power generation system can collectively supply an output of electrical power together, or the marine production system receives electrical power from the wind power generation systems for performing a desired operation. With such an arrangement, diverse operations can be performed in the on-sea plant site to advance the efficiency of development and exploitation thereof.

### TECHNICAL FIELD OF THE INVENTION

The present invention generally relates to an offshore renewable power plant, and more particularly to an offshore compound renewable power plant, which comprises an ocean energy based power generation system and/or an on-sea production system.

### DESCRIPTION OF THE PRIOR ART

Economic development, population growth, and progress of industry make an increasing rise of the worldwide consumption of electrical power. Fossil fuel is the major source of energy supply for the modem society.

However, fossil fuel is very limited resources of the earth. Further, combustion of fossil fuel generates server pollution of the atmosphere and also emits a large amount of greenhouse gases, including carbon dioxide, which leads to a deteriorating effect of global warming. Thus, developing clean renewable energies as substitutes for fossil fuel is now a primary target of the energy strategies of modem countries.

The renewable energies include solar energy, wind power, geothermal energy, biomass energy hydropower, and ocean energy. Wind power is one of the fastest growing renewables. A wind power generator system comprises a windmill that receives and converts wind power into electrical power. The wind power generator systems are often installed at areas having strong winds or air streams to ensure the generation of sufficient electrical power. It is apparent that a wind power generator system having a great size and installed at a high altitude would receive stronger winds blowing in high sky and thus provide an increased amount of electrical power. Due to the adverse factors, including terrain, shelter, and other factors, found on the land, it is difficult to get a proper site for construction of wind power generation systems of large scales. On the other hand, the surface temperature of an ocean area is much more stable as compared to the land and the wind field of an ocean area is also more stable, both making ocean a better choice for development and construction of wind power generation. Offshore wind power plants are an alternative solution for development of wind power generation, which is now getting worldwide attention.

However, the existing technology of offshore power generation only works for generation of electrical power with winds. It is a pity that a large number of wind power generation systems are installed in an ocean area without further making use of the rich and diverse energy resources provided by the ocean. Thus, the present invention aims to provide a compound power plant that further advance the efficiency of offshore renewable energy based power generation.

### SUMMARY OF THE INVENTION

The primary objective of the present invention is to provide an offshore compound renewable power plant, which sets up both wind power generation systems and ocean energy based power generation systems in an on-sea plant site to collectively supply an output of electrical power so as to fully use the natural resources available in the on-sea plant site for diverse utilization and to increase total amount of electrical power generated by the plant.

Another objective of the present invention is to provide an offshore compound renewable power plant, which sets up both wind power generation systems and marine production systems, so that the marine production systems can be operated by the electrical power supplied from the wind power generation systems for fully using the natural resources of the on-sea plant site and also for diverse utilization and that electrical power transmission system that feed electrical power from the wind power generation systems to the marine production systems can be simplified due to the neighboring arrangement of the marine production systems to the wind power generation systems.

A further objective of the present invention is to provide an offshore compound renewable power plant, which adopts vertical axis wind power generators to serve as the wind power generation systems so that multi-layered power generation facility can be realized with a stacked arrangement and thus the total amount of electrical generated by a single marine platform can be increased.

Yet a further objective of the present invention is to provide an offshore compound renewable power plant, which comprises wind power generation systems that are combined with solar energy operated electrical power supply devices for using the naturally available sun light to diversify the supply sources of electrical power and effectively increase the amount of electrical power generated thereby.

To achieve the above objectives, according to the present invention, an offshore compound renewable power plant is provided. The offshore compound renewable power plant is built in an on-sea plant site and comprises a plurality of marine platforms, a plurality of wind power generation systems, and at least one ocean energy based power generation system. The marine platforms are set up in the on-sea plant site in a spaced manner and each has a platform located above the sea surface. The wind power generation systems are respectively installed on the marine platforms for receiving winds to generate electrical power. The ocean energy based electrical power generation system is set up in an ocean area inside the on-sea plant site to acquire ocean energy for generation of electrical power. The wind power generation systems and the ocean energy based electrical power generation system collectively supply an output of electrical power together.

The ocean energy based electrical power generation system selectively comprises a wave power generation system, an ocean thermal energy power generation system, an ocean current power generation system, or a tidal power generation system.

In a preferred embodiment, the wind power generation system comprises a vertical axis wind power generator, and may further comprise a solar energy operated electrical power supply device mounted atop the vertical axis wind power generator.

In a preferred embodiment, the wind power generation system comprises a plurality of vertical axis wind power generators that is stacked in a vertical direction, and may further comprise a solar energy operated electrical power supply device mounted atop the vertical axis wind power generators.

In another aspect, the present invention provides an offshore compound renewable power plant, which is built in an on-sea plant site. The offshore compound renewable power plant comprises a plurality of marine platforms, a plurality of wind power generation systems, and at least one marine production system. The marine platforms are set up in the on-sea plant site in a spaced manner, and each has a platform located above sea surface. The wind power generation systems are respectively installed on the marine platforms for receiving winds to generate electrical power. The marine production system is set up in an ocean area inside the on-sea plant site to receive electrical power from the wind power generation systems for performing a desired operation.

The marine production system selectively comprises an electrolysis based hydrogen generation system, a seawater desalination system, or a biomass diesel generation system.

In a preferred embodiment, wind power generation system comprises a vertical axis wind power generator; and may further comprise a solar energy operated electrical power supply device mounted atop the vertical axis wind power generator.

In a preferred embodiment, the wind power generation system comprises a plurality of vertical axis wind power generators that is stacked in a vertical direction, and may further comprise a solar energy operated electrical power supply device mounted atop the vertical axis wind power generators.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a schematic view of layout of an offshore compound renewable power plant according to the present invention.

FIG. 2 shows the structure of a first embodiment of a wind power generation system according to the present invention.

FIG. 3 shows the structure of a second embodiment of the wind power generation system according to the present invention.

FIG. 4 shows the structure of a third embodiment of the wind power generation system according to the present invention.

FIG. 5 shows a schematic layout of a first embodiment of an offshore compound renewable power plant according to the present invention.

FIG. 6 shows a schematic layout of a second embodiment of the offshore compound renewable power plant according to the present invention.

FIG. 7 shows a schematic layout of a third embodiment of the offshore compound renewable power plant according to the present invention.

FIG. 8 shows a schematic layout of a fourth embodiment of the offshore compound renewable power plant according to the present invention.

FIG. 9 shows a schematic layout of a fifth embodiment of the offshore compound renewable power plant according to the present invention.

FIG. 10 shows a schematic layout of a sixth embodiment of the offshore compound renewable power plant according to the present invention.

FIG. 11 shows a schematic layout of a seventh embodiment of the offshore compound renewable power plant according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides an offshore compound renewable power plant, which is aimed at diverse use of a marine plant site in order to realize the maximum efficiency of development and exploitation of the plant site.

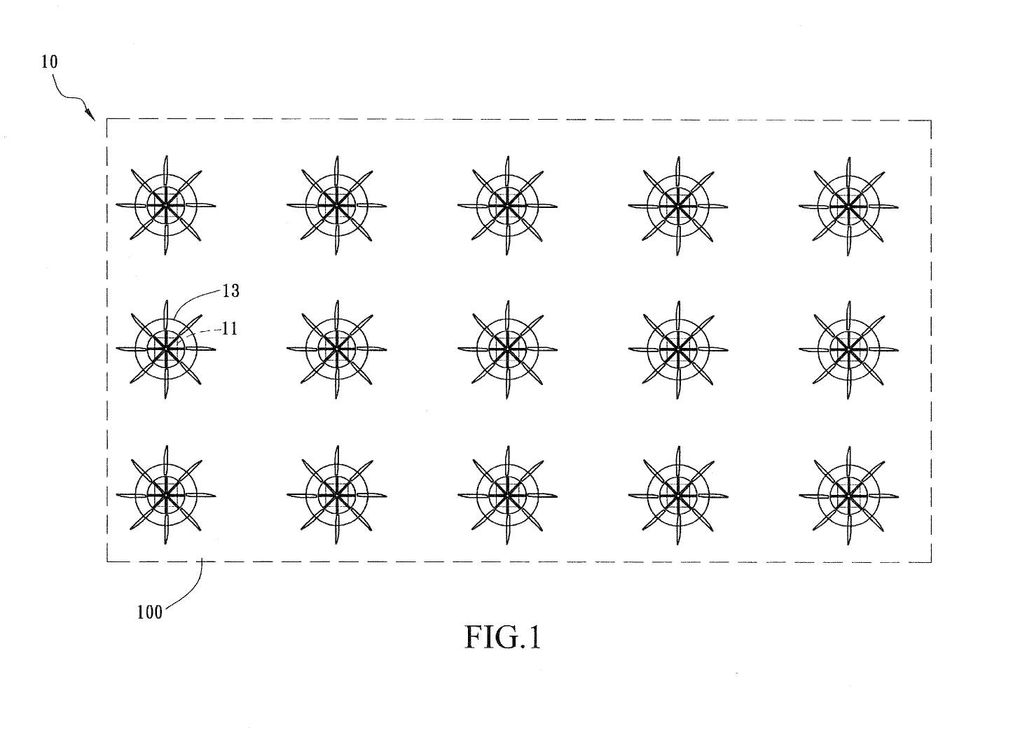

Reference is first made to FIG. 1, which shows a schematic view of layout of an offshore compound renewable power plant according to the present invention. The offshore compound renewable power plant of the present invention, generally designated at 10, is built in an on-sea plant site 100 and comprises a plurality of marine platforms 11 and a plurality of wind power generation systems 13. The marine platforms 11 are built in the on-sea plant site 100 and spaced from each other, each comprising a platform that is located above the sea surface. The wind power generation systems 13 are respectively installed on the marine platforms 11 to receive winds blowing above the sea surface for generation and supply of electrical power.

The feature of the present invention is that the offshore compound renewable power plant 10 of the present invention further comprise an ocean energy based power generation system or a marine production system (not shown in the drawing) for the purpose of fully using the ocean resources to thereby realize diverse operation of the on-sea plant site 100. This will be further described.

Another feature of the present invention is that the wind power generation systems 13 comprise vertical axis wind power generators.

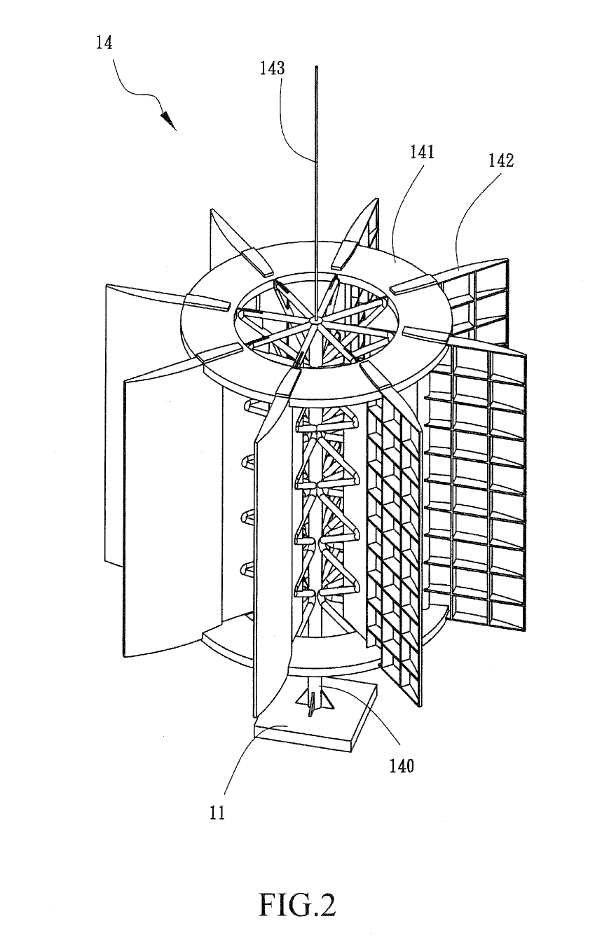

Referring to FIG. 2, which shows the structure of a first embodiment of the wind power generation system according to the present invention, the wind power generation system of the present invention, which is now designated with reference numeral 14, comprises a vertical axis wind power generator. The wind power generator 14 comprises a central shaft 140 vertically mounted on the marine platform 11 at a bottom thereof and comprising a lightning rod 143 mounted to a top thereof. The wind power generator 14 comprises a cylindrical frame 141 having a circumference along which a plurality of blades 142 is mounted in a spaced manner for receiving and thus being driving by winds to rotate the frame 141 around the central shaft 140, which in turns drives a dynamo arranged therein to generate and supply electrical power.

A horizontal axis wind power generator must be set to align with the direction of air flows or winds. However, a vertical axis wind power generator does not need to consider the direction of winds. Further, the vertical axis wind power generator has a symmetric and stable structure, which allows for the construction of a multi-layered power generation arrangement.

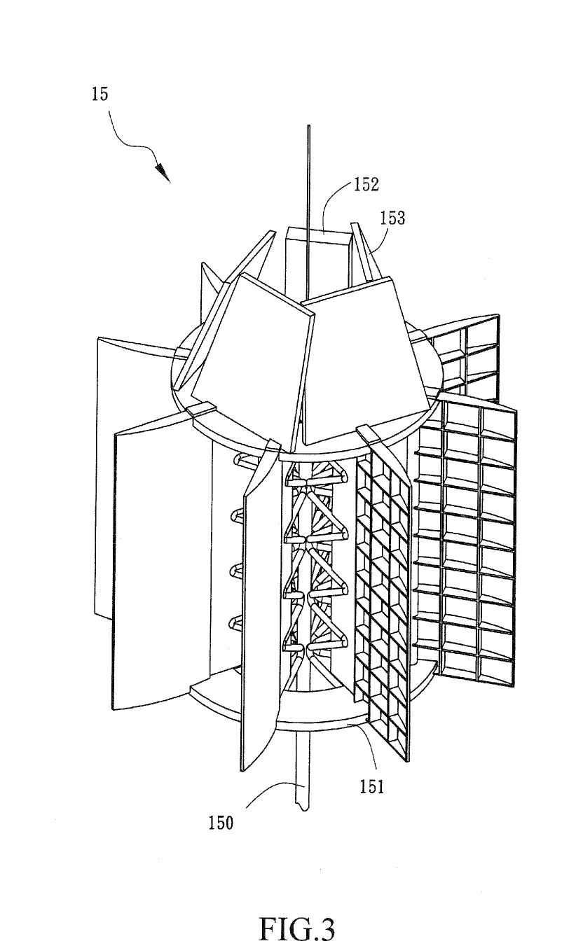

Referring to FIG. 3, which shows the structure of a second embodiment of the wind power generation system according to the present invention, the wind power generation system of the present invention, which is designated at 15, comprises a vertical axis wind power generator 151 and a solar energy operated electrical power supply device 152. The wind power generation system 15 comprises a central shaft 150, which is mounted at a lower end to a marine platform. The solar energy operated electrical power supply device 152 comprises solar panels 153 that are mounted atop the vertical axis wind power generator 151 in a partially-overlapped conic arrangement for receiving and converting sun light into electrical power for output. In this way, the rich solar energy available in the ocean site can be used to increase the amount of electrical power acquired and to diversify the supply sources of electrical power.

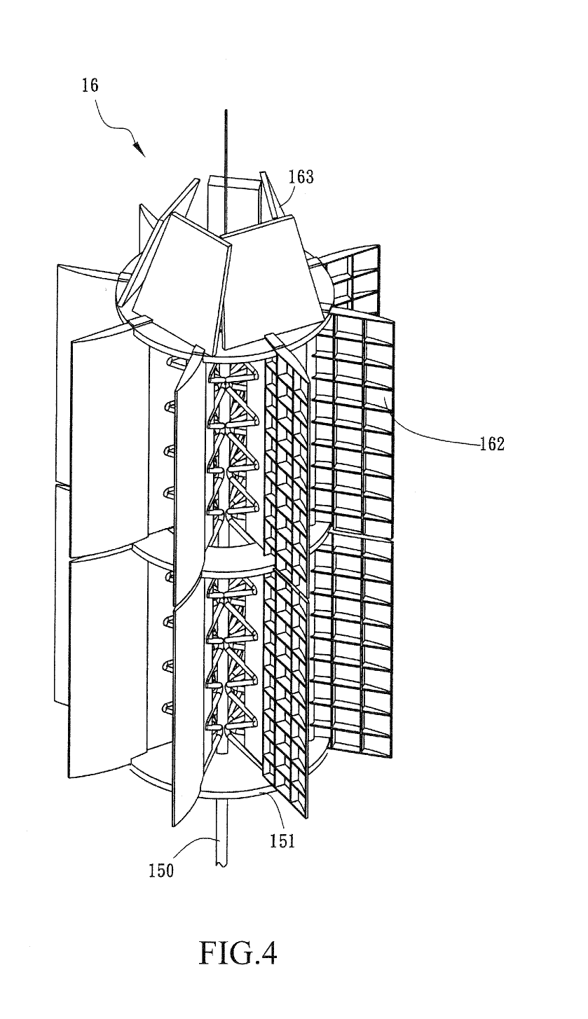

Referring to FIG. 4, which shows the structure of a third embodiment of the wind power generation system according to the present invention, the wind power generation system according to the present invention, which is designated at 16, comprises two vertical axis wind power generators 161, 162 and a solar energy operated electrical power supply device 163. The wind power generation system has a central shaft 160, which is mounted at a lower end to a marine platform. The vertical axis wind power generators 161, 162 are stacked vertically and the solar energy operated electrical power supply device 163 comprises solar panels that are mounted atop the vertical axis wind power generator 162 in a partially-overlapped conic arrangement. The arrangement of two layered wind power generation can receive strong winds of high altitude to increase the amount of electrical power generated thereby. In this way, a single marine platform can supply approximately double electrical power so that the cost of electrical power generation can be reduced.

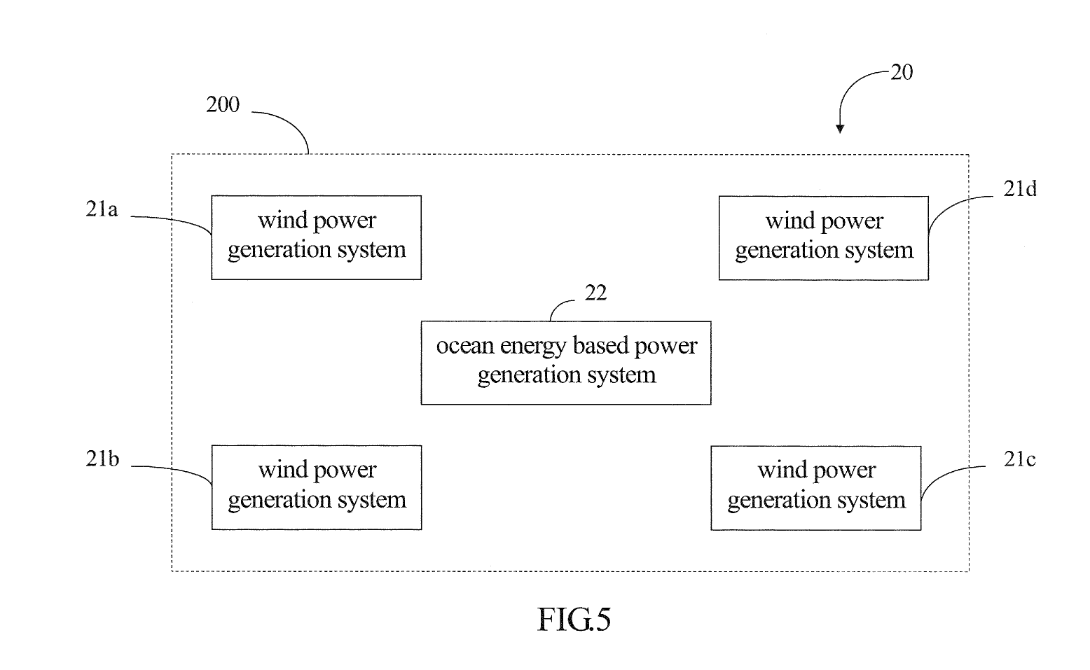

Referring to FIG. 5, which shows a schematic layout of a first embodiment of the offshore compound renewable power plant according to the present invention, the offshore compound renewable power plant according to the present invention, which is now designated with reference numeral 20, is built in an on-sea plant site 200 and comprises a plurality of wind power generation systems 21a, 21b, 21c, 21d and an ocean energy based power generation system 22. The ocean energy based power generation system 22 is arranged in the sea area inside the on-sea plant site 200 to generate electrical power by means of the natural resources of the ocean and thus supply electrical power together with the wind power generation systems 21a, 21b, 21c, 21d. In this way, the natural resources of the ocean area of the on-sea plant site 200 can be fully used to increase the total amount of electrical power that can be acquired by the offshore compound renewable power plant 20.

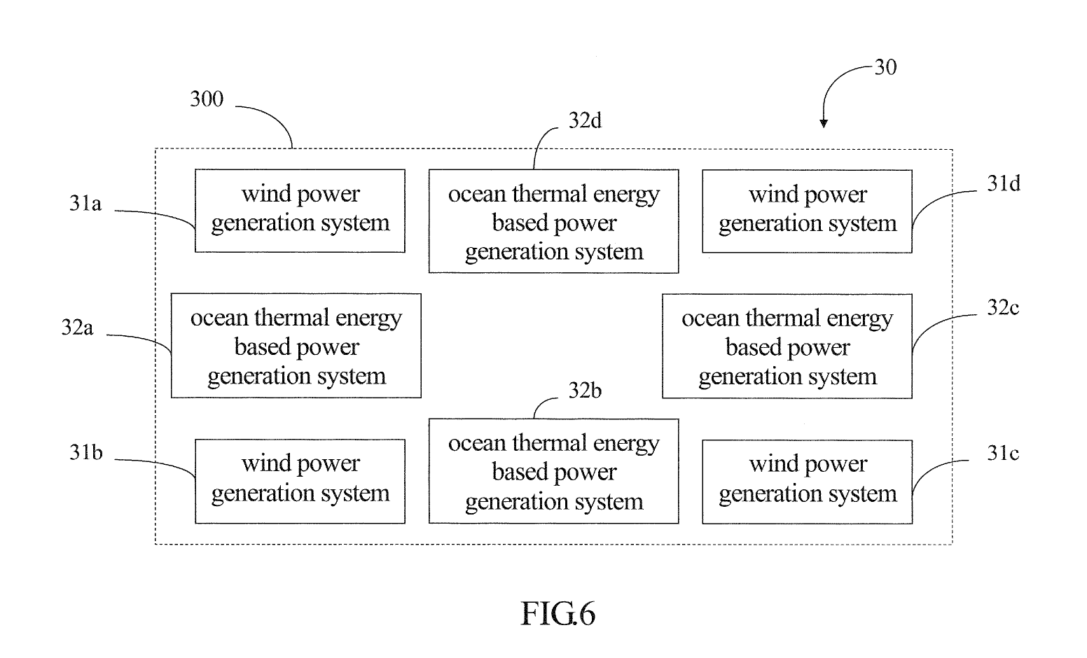

Referring to FIG. 6, which shows a schematic layout of a second embodiment of the offshore compound renewable power plant according to the present invention, the offshore compound renewable power plant according to the present invention, which is now designated with reference numeral 30, comprises a plurality of wind power generation systems 31a, 31b, 31c, 31d and an ocean thermal energy based power generation systems 32a, 32b, 32c, 32d built in an on-sea plant site 300. The ocean thermal energy based power generation systems 32a, 32b, 32c, 32d are a type of ocean energy based electrical power generation system, which is operate by the difference of temperature between different depths of the ocean, in which warm sea water is used to generate vapor in a closed-loop circulation system or a vacuum chamber for driving a turbo power generator to supply electrical power and cold sea water then cools and converts the vapor into liquid. The ocean thermal energy based power generation systems 32a, 32b, 32c, 32d can be arranged in the ocean areas between the spaced wind power generation systems 31a, 31b, 31c, 31d, and/or under the sea surface below the marine platforms.

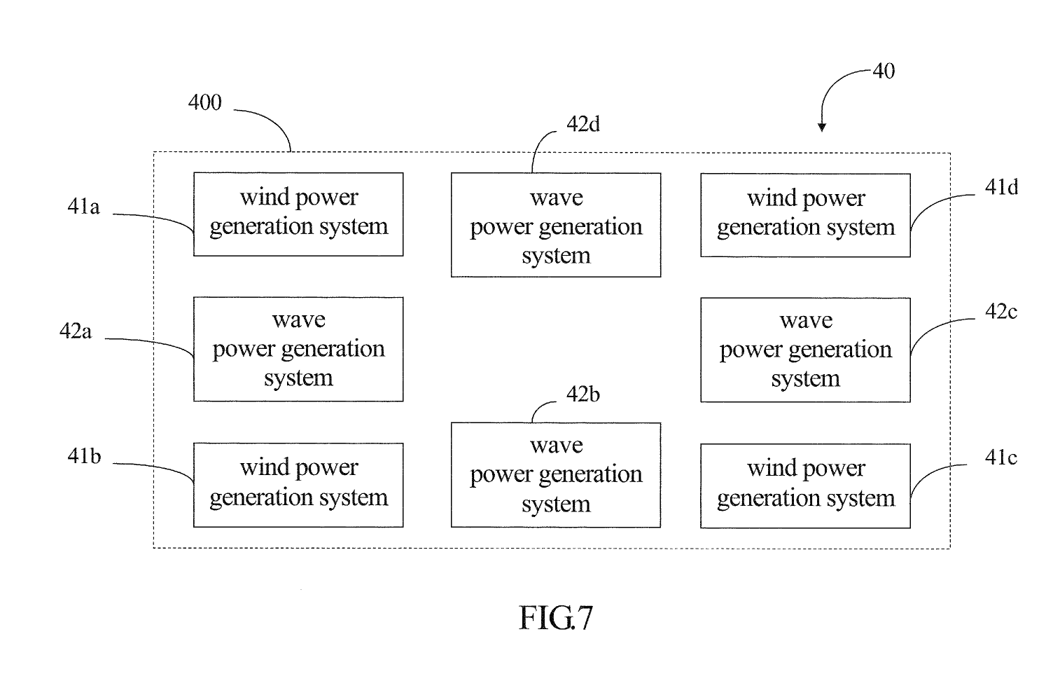

Referring to FIG. 7, which shows a schematic layout of a third embodiment of the offshore compound renewable power plant according to the present invention, which is an expansion of the first embodiment of the offshore compound renewable power plant, the offshore compound renewable power plant according to the present invention, which is now designated with reference numeral 40, comprises a plurality of wind power generation systems 41a, 41b, 41c, 41d and wave power generation system 42a, 42b, 42c, 42d built in an on-sea plant site 400. The wave power generation systems 42a, 42b, 42c, 42d are a type of ocean energy based electrical power generation system, which comprises a hollow structure and is operate by the difference of altitude of up and down movements of ocean waves that drives air contained in the hollow structure to thereby generate strong air flows to drive turbo power generators for generation of electrical power. The wave power generation systems 42a, 42b, 42c, 42d can be arranged in the ocean areas between the spaced wind power generation systems 41a, 41b, 41c, 41d, and/or under the sea surface below the marine platforms

Besides the above discussed embodiments, other types of ocean energy based electrical power generation can be adopted, including ocean current power generation and tidal power generation. The ocean current power generation is carried out by using ocean currents to rotate a turbine, which in turn drives a dynamo to generate electrical power. The tidal power generation is carried out by using altitude difference between high and low tides to rotate a hydraulic turbine, which in turn drives a dynamo to generate electrical power. All these ocean energy based power generation systems require different geographic condition, so that the offshore compound renewable power plant of the present invention can be constructed as versatile ocean energy based power generation system, which is installed at a proper ocean area according to the requirements of power generation.

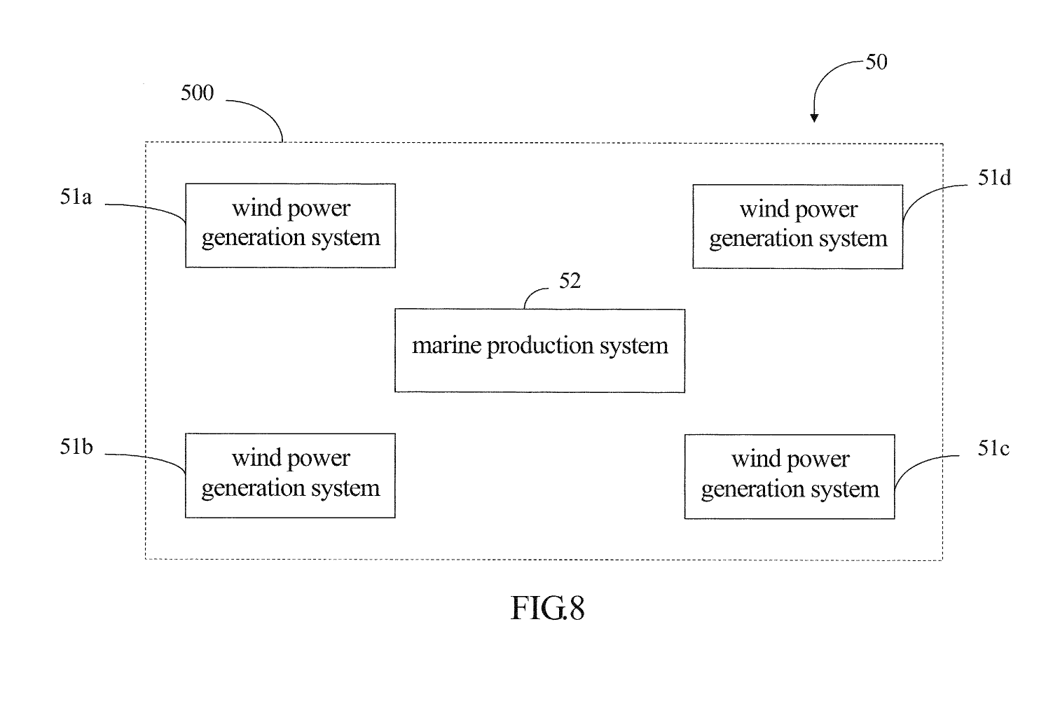

Referring to FIG. 8, which shows a schematic layout of a fourth embodiment of the offshore compound renewable power plant according to the present invention, the offshore compound renewable power plant according to the present invention, which is now designated with reference numeral 50, is built in an on-sea plant site 500 and comprises a plurality of wind power generation systems 51a, 51b, 51c, 51d and a marine production system 52. The marine production system 52 is set up in an internal ocean area inside the on-sea plant site 500 and is operated by the electrical power generated by the wind power generation systems 51a, 51b, 51c, 51d to accomplish a desired manufacturing or production process. Since the marine production system 52 is set up in the internal ocean area inside the on-sea plant site 500, there is no need for the production facility to occupy valuable on-land area; and since the marine production system 52 is located adjacent to the wind power generation systems 51a, 51b, 51c, 51d, the transmission of electrical power from the power generation systems to the marine production system can be simplified.

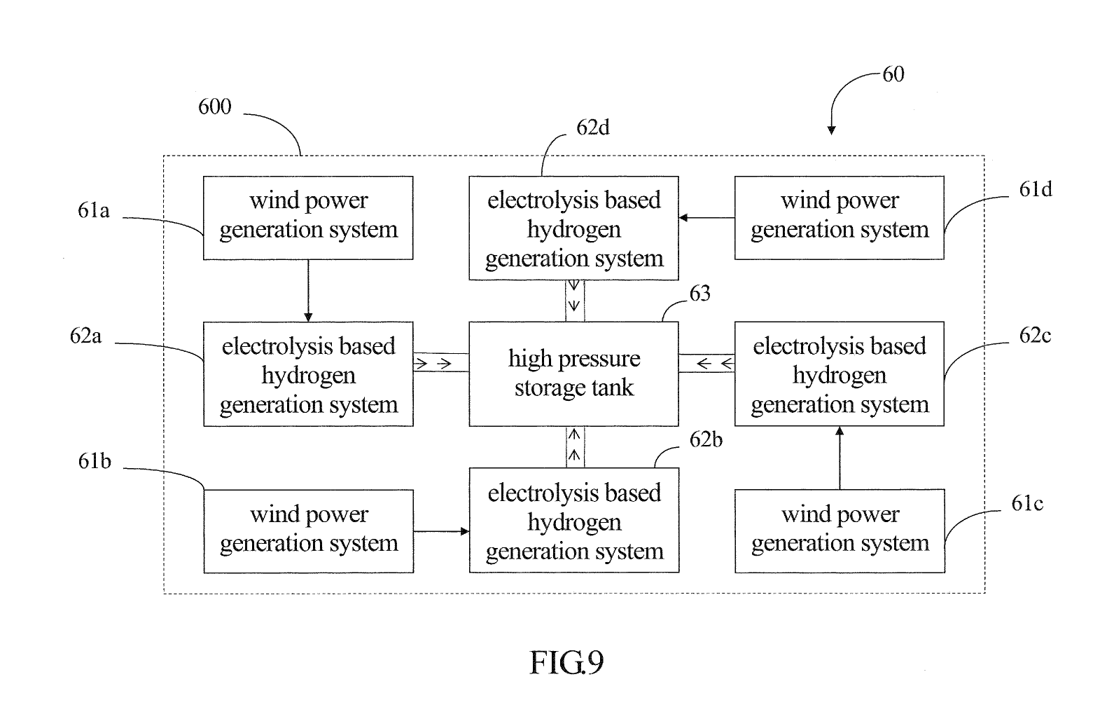

Referring to FIG. 9, which shows a schematic layout of a fifth embodiment of the offshore compound renewable power plant according to the present invention, which is an expansion of the fourth embodiment, the offshore compound renewable power plant according to the present invention, which is now designated with reference numeral 60, comprises a plurality of wind power generation systems 61a, 61b, 61c, 61d, electrolysis based hydrogen generation systems 62a, 62b, 62c, 62d, and a high pressure storage tank 63, which are built in an on-sea plant site 600. The electrolysis based hydrogen generation systems 62a, 62b, 62c, 62d receive electrical power from the wind power generation systems 61a, 61b, 61c, 61d to carry out the electrolysis processes for generation of hydrogen gas, which is then fed through piping systems to the high pressure storage tank 63 for storage. Since hydrogen is an important substance for industrial use, and is also a dangerous gas of high flammability, the manufacturing site must be highly secured. According to the present invention, the hydrogen manufacturing facility is moved to an on-sea plant site 600 and this eliminates any possible potential threaten to safety of the land.

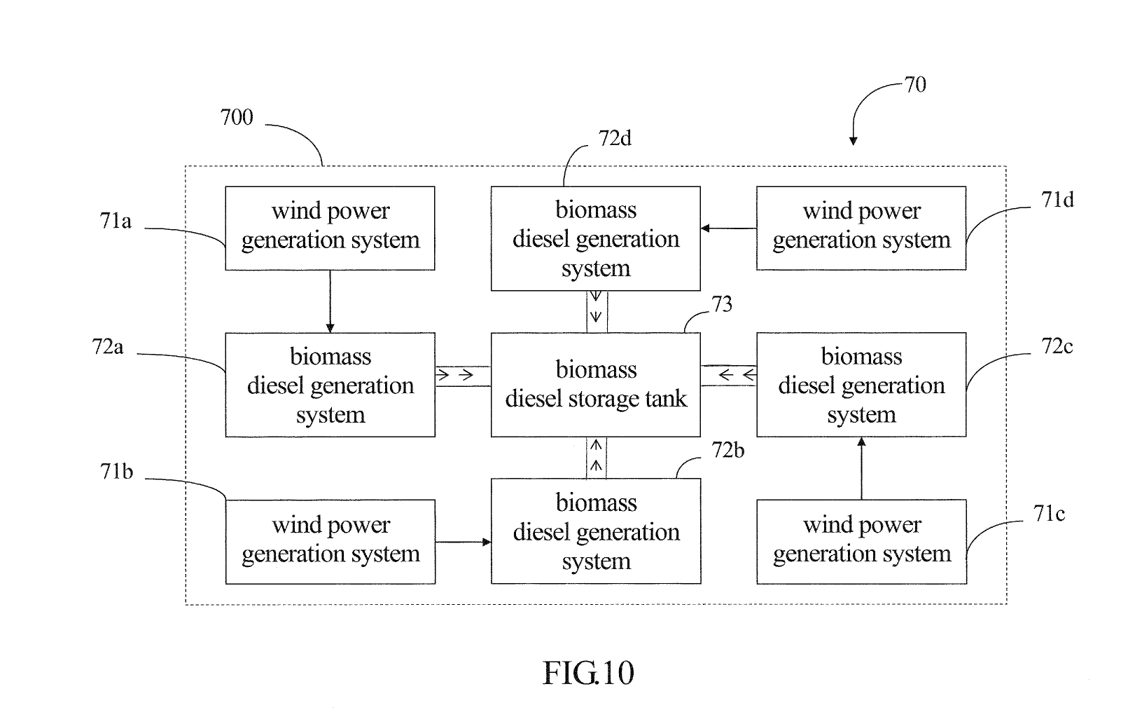

Referring to FIG. 10, which shows a schematic layout of a sixth embodiment of the offshore compound renewable power plant according to the present invention, which is an expansion of the fourth embodiment, the offshore compound renewable power plant according to the present invention, which is now designated with reference numeral 70, comprises a plurality of wind power generation systems 71a, 71b, 71c, 71d, biomass diesel generation systems 72a, 72b, 72c, 72d, and a biomass diesel storage tank 73, which are built in an on-sea plant site 700. Biomass diesel is obtained through refining organic substances, and aquaculture may breed and grow ocean organic substances, such as seed weeds, which can be refined for biomass diesel. The biomass diesel generation systems 72a, 72b, 72c, 72d receive electrical power from the wind power generation systems 71a, 71b, 71c, 71d to carry out seed weed refining processes for generation of diesel, which is then fed through piping systems to the biomass diesel storage tank 73 for storage.

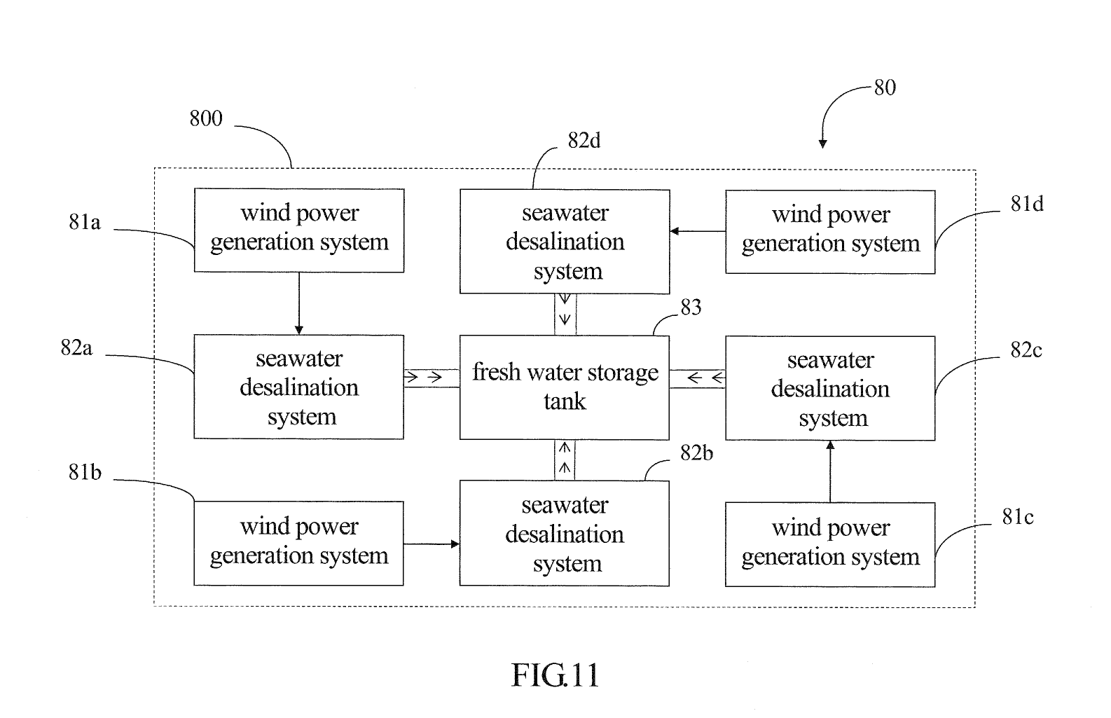

Referring to FIG. 11, which shows a schematic layout of a seventh embodiment of the offshore compound renewable power plant according to the present invention, which is an expansion of the fourth embodiment, the offshore compound renewable power plant according to the present invention, which is now designated with reference numeral 80, comprises a plurality of wind power generation systems 81a, 81b, 81c, 81d, seawater desalination systems 82a, 82b, 82c, 82d, and a fresh water storage tank 83, which are built in an on-sea plant site 800. The seawater desalination systems 82a, 82b, 82c, 82d receive electrical power from the wind power generation systems 81a, 81b, 81c, 81d to carry out the seawater desalination processes, such as dialysis and distillation, for generation of fresh water, which is then fed through piping systems to the fresh water storage tank 83 for storage.

It is noted that the offshore compound renewable power plant according to the present invention can be arranged to simultaneously include various marine production systems and ocean energy based power generation systems, which are set up in proper zones inside an on-sea plant site. The present invention aims to provide a versatile arrangement of offshore compound renewable power plant, of which all the constituent sub-systems are generally known so that further detail is not needed herein.

In summary, the offshore compound renewable power plant according to the present invention comprises both wind power generation systems installed on marine platforms in an on-sea plant site and ocean energy based power generation systems and/or marine production systems in the on-sea plant site in order to realize versatile operations of the on-sea plant site and thus advance the efficiency of development and exploitation of the on-sea plant site. Further, by adopting the vertical axis wind power generators as the wind power generation systems, a multi-layered arrangement of electrical power generation system can be realized for increasing the amount of electrical power generated.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An offshore compound renewable power plant built in an on-sea plant site, the offshore compound renewable power plant comprising:
a plurality of marine platforms, which is set up in the on-sea plant site in a spaced manner, each of the marine platforms comprising a platform located above sea surface;
a plurality of wind power generation systems, which is respectively installed on the marine platforms for receiving winds to generate electrical power; and
at least one ocean energy based electrical power generation system, which is set up in an ocean area inside the on-sea plant site to acquire ocean energy for generation of electrical power;
wherein the wind power generation systems and the ocean energy based electrical power generation system supply an output of electrical power together.

2. The offshore compound renewable power plant according to claim 1, wherein the wind power generation systems comprise a vertical axis wind power generator.

3. The offshore compound renewable power plant according to claim 1, wherein the wind power generation systems comprise a plurality of vertical axis wind power generators that is stacked in a vertical direction.

4. The offshore compound renewable power plant according to claim 2, wherein the wind power generation systems comprise a solar energy operated electrical power supply device.

5. The offshore compound renewable power plant according to claim 3, wherein the wind power generation systems comprise a solar energy operated electrical power supply device.

6. The offshore compound renewable power plant according to claim 1, wherein the ocean energy based electrical power generation system comprises an electrical power generation system selected from a group consisting of wave power generation system, ocean thermal energy power generation system, ocean current power generation system, and tidal power generation system.

7. An offshore compound renewable power plant built in an on-sea plant site, the offshore compound renewable power plant comprising:
a plurality of marine platforms, which is set up in the on-sea plant site in a spaced manner, each of the marine platforms comprising a platform located above sea surface;
a plurality of wind power generation systems, which is respectively installed on the marine platforms for receiving winds to generate electrical power; and
at least one marine production system, which is set up in an ocean area inside the on-sea plant site to receive electrical power from the wind power generation systems for performing a desired operation.

8. The offshore compound renewable power plant according to claim 7, wherein the wind power generation systems comprise a vertical axis wind power generator.

9. The offshore compound renewable power plant according to claim 7, wherein the wind power generation systems comprise a plurality of vertical axis wind power generators that is stacked in a vertical direction.

10. The offshore compound renewable power plant according to claim 8, wherein the wind power generation systems comprise a solar energy operated electrical power supply device.

11. The offshore compound renewable power plant according to claim 9, wherein the wind power generation systems comprise a solar energy operated electrical power supply device.

12. The offshore compound renewable power plant according to claim 7, wherein the marine production system comprises a system selected from a group consisting of electrolysis based hydrogen generation system, seawater desalination system, and biomass diesel generation system.
